(19) United States
(12) Patent Application Publication
(10) Pub. No.: US 2026/0260323 A1
(43) Pub. Date: Sep. 3, 2026

(54) BALLAST CONDITION MONITORING SYSTEM, BALLAST CONDITION MONITORING DEVICE, AND BALLAST CONDITION MONITORING METHOD

(71) Applicant: Kawasaki Railcar Manufacturing Co., Ltd., Kobe-shi, Hyogo (JP)

(72) Inventor: Yusuke NISHIO, Kobe-shi, Hyogo (JP)

(73) Assignee: Kawasaki Railcar Manufacturing Co., Ltd., Kobe-shi, Hyogo (JP)

(21) Appl. No.: 18/863,665

(22) PCT Filed: Dec. 28, 2022
(86) PCT No.: PCT/JP2022/048478

§ 371 Date: Nov. 7, 2024

(51) Int. Cl. G06T 7/00; G01B 11/24; G06T 7/13; G06T 7/60

(52) U.S. Cl. CPC G06T 7/0002; G01B 11/24; G06T 7/13; G06T 7/60; G06T 2207/30184; G06T 2207/30242

(57) ABSTRACT

A ballast condition monitoring system includes: an input part to which data indicating a surface condition of a ballast in a railroad track is inputted; a processing part calculating an index value indicating a degree of grain size of the ballast based on the data indicating the surface condition of the ballast inputted to the input part; and a maintenance necessity determination processing part determining necessity of maintenance based on the index value.

### CROSS-REFERENCE TO RELATED APPLICATION

The present application is a National Phase entry based on PCT Application No. PCT/JP2022/048478 filed on Dec. 28, 2022, the entire contents of which is incorporated herein by reference.

### BACKGROUND

### Technical Field

The present disclosure relates to a technique of monitoring a condition of a ballast in a railroad track on which a railroad car runs.

### Background Art

Patent Document 1 discloses a technique of analyzing each image data recorded in running of a railroad inspection car to obtain a cross-sectional shape of a ballast and calculate a cross-sectional scale, and determining that a ballast condition is defective when the cross-sectional scale is larger than a reference value, and detecting a collapsed part, and displaying the cross-sectional shape and positional data.

### BACKGROUND ART DOCUMENTS

### Patent Document(S)

Patent Document 1: Japanese Patent Application Laid-Open No. 7-294443

### SUMMARY

A ballast condition monitoring system includes: an inputter to which data indicating a surface condition of a ballast in a railroad track is inputted; circuitry configured to calculate an index value indicating a degree of grain size of the ballast based on the data indicating the surface condition of the ballast inputted to the inputter; and determine necessity of maintenance based on the index value.

A ballast condition monitoring device includes: an inputter to which data indicating a surface condition of a ballast in a railroad track is inputted; and circuitry configured to calculate an index value indicating a degree of grain size of the ballast based on the data indicating the surface condition of the ballast inputted to the inputter.

A ballast condition monitoring method detects a surface condition of a ballast in a railroad track, calculates an index value indicating a degree of grain size of the ballast based on data indicating the surface condition of the ballast, and outputs a result of the calculation.

### BRIEF DESCRIPTION OF DRAWINGS

FIG. 1 is a block diagram illustrating a ballast condition monitoring system according to an embodiment.

FIG. 2 is a block diagram illustrating a ballast condition monitoring device.

FIG. 3 is an explanation diagram illustrating an example of a condition and a detection target line of a ballast between rails.

FIG. 4 is an explanation diagram illustrating an example of a condition and a detection target line of a ballast between rails.

FIG. 5 is a flow chart illustrating a processing example of an index value calculation device.

FIG. 6 is an explanation diagram illustrating a processing example of fractal dimension analysis by a box counting method.

FIG. 7 is an explanation diagram illustrating a processing example of fractal dimension analysis by a box counting method.

FIG. 8 is an explanation diagram illustrating a processing example of fractal dimension analysis by a box counting method.

FIG. 9 is an explanation diagram illustrating a processing example of calculating an arithmetic average roughness.

FIG. 10 is a flow chart illustrating a processing example of a determination processing device.

FIG. 11 is a diagram illustrating an example of a ballast condition image.

### DESCRIPTION OF EMBODIMENTS

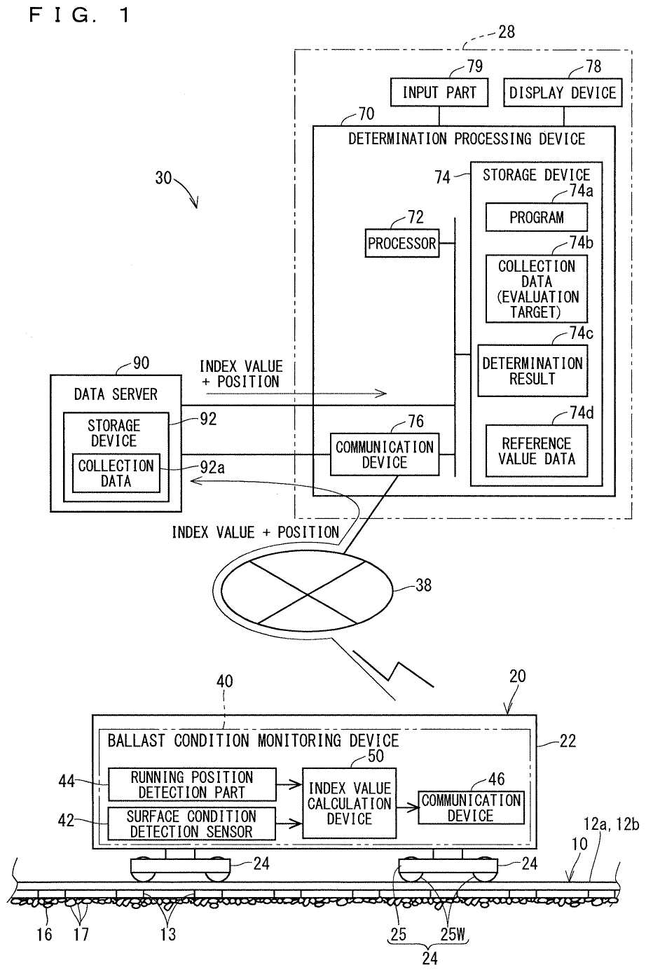

Described hereinafter are a ballast condition monitoring device, a ballast condition monitoring system, and a ballast condition monitoring method according to an embodiment. FIG. 1 is a block diagram illustrating a whole configuration of a ballast condition monitoring system 30.

An example of a railway track 10 monitored by the present system 30 is described. The railroad track 10 is a road guiding a railroad car 20 along a predetermined path. The railroad track 10 herein includes a first rail 12a and a second rail 12b. The two rails 12a and 12b are fixed on a ballast 16 via a tie 13.

The ballast 16 is a track bed supporting the rails 12a and 12b. The ballast 16 includes block objects 17 spread on a laying surface. The block object 17 is a crushed stone made by crushing a rock or a gravel, for example. The laying surface may be a surface of a land, a lower side surface in a tunnel, or an upper surface of a bridge or a via duct, for example. The tie 13 is located on the ballast 16. The tie 13 is a rectangular parallelepiped member intervening between the ballast 16 and the two rails 12a and 12b to support the rails 12a and 12b. That is to say, the ties 13 are disposed on the ballast 16 in a parallel posture at intervals in an extension direction of the rails 12a and 12b. The two rails 12a and 12b are disposed on the ties 13 in a posture perpendicular to the ties 13 at intervals in the extension direction of the ties 13. The rails 12a and 12b are fixed to the ties 13 by a fastener such as a spike.

The railroad car 20 includes a body 22 and trucks 24. The trucks 24 each include a truck frame 25 and wheels 25 W. The wheels 25 W are rotatably supported in left and right portions of the truck frame 25 via an axle. A part supporting the axle is also referred to as an axle box. A direction of run and a direction of backing of the railroad car 20 are also respectively referred to as a forward direction and a backward direction in the present embodiment. Left and right sides are referred to left and right sides as viewed in the direction of run from the railroad car 20 in some cases. A side to which gravity is applied in a direction of gravity is also referred to as a lower side, and a side opposite the lower side is also referred to as an upper side. The right and left wheels 25 W run on the two rails 12a and 12b while being guided by the two rails 12a and 12b. The trucks 24 support the body 22 from below. The trucks 24 run on the railroad track 10, thus the railroad car 20 including the body 22 runs along the railroad track 10. The railroad car 20 may be any of an electric train, a locomotive and a freight car of a freight train, and a locomotive and a passenger car of a passenger train as long as it runs on the railroad track 10. The freight train or the passenger train may be a trailing car towed by the locomotive, or may be a motive power car having its motive power. The locomotive may be an electric locomotive, or may be an internal combustion locomotive, such as a diesel locomotive. The railroad car 20 may be a commercial car for transporting a human or a baggage, or may also be a business car for monitoring a railroad track condition. The railroad car 20 may be a land railer which can run on both a railroad track and a road.

The ballast 16 has a function of diffusing vibration of the railroad car 20 described above passing on the rails 12a and 12b to the laying surface. The ballast 16 has functions of improving drainage performance and preventing growth of plant weeds.

It is considered that the block objects 17 have contact with each other in accordance with running of the railroad car 20, and grain sizes of the block objects 17 constituting the ballast 16 decrease. When decrease in the grain sizes of the block objects 17 proceeds, it is considered that the functions of diffusing the vibration, draining water, and preventing the growth of plant weeds described above are lost. When the decrease in the grain sizes of the block objects 17 proceeds, the block objects 17 which have been spread are replaced. It is considered that a degree of grain size of the block object 17 is visually observed to determine necessity of replacement. In this case, an inspector goes to an actual area where the ballast 16 is spread to confirm the degree of grain sizes of the block objects 17, thus a work burden for inspection increases. A qualitative determination by a person tends to be performed in the visual inspection, thus it is considered that variation occurs in the determination of necessity of replacement.

The present embodiment relates to a technique for easily and quantitively determining the degree of grain sizes of the block objects 17 spread as the ballast 16.

As illustrated in FIG. 1, the ballast condition monitoring system 30 is a system for monitoring a condition of the block objects 17 spread in the ballast 16 in the railroad track 10, and includes a ballast condition monitoring device 40 and a determination processing device 70.

The ballast condition monitoring device 40 is a device calculating an index value for monitoring the condition of the ballast 16. In the present embodiment, the ballast condition monitoring device 40 includes a surface condition detection sensor 42, a running position detection part 44, an index value calculation device 50, and a communication device 46. The ballast condition monitoring device 40 is incorporated into the railroad car 20.

The surface condition detection sensor 42 detects a surface condition of the ballast 16 during running on the railroad track 10. The running position detection part 44 detects a running position of the railroad car 20 in the railroad track 10. Output from the surface condition detection sensor 42 and the running position detection part 44 is inputted to the index value calculation device 50. The index value calculation device 50 calculates an index value indicating the degree of grain sizes of the block objects 17 spread as the ballast 16 based on data indicating the surface condition of the ballast 16 in the railroad track 10. The calculated index value is outputted to the communication device 46 as data associated with a position in the railroad track 10. The communication device 46 transmits data in which the index value and a position in the railroad car 20 are associated with each other.

The ballast condition monitoring device 40 and the determination processing device 70 are communicably connected to a data server 90. For example, the ballast condition monitoring device 40 is communicably connected to the data server 90 via a communication network 38 and a communication device 76. The determination processing device 70 is communicably connected to the data server 90 in a wired system. Each of the determination processing device 70 and the data server 90 may include a communication device which can be communicated via the communication network 38. In this case, the communication between the ballast condition monitoring device 40, the determination processing device 70, and the data server 90 can be performed via the communication network 38. The data server 90 is a computer including a storage device 92. The data server 90 may be a cloud server. The index value as a calculation result is transmitted to the data server 90 as the data associated with the running position of the railroad car 20 via the communication network 38. Accordingly, the storage device 92 of the data server 90 stores collection data 92a in which the index value and the position in the railroad track 10 are associated with each other.

The data server 90 may store data transmitted from the railroad cars 20. The data server 90 collects data transmitted from the railroad cars 20, thus the index value of the railroad track 10 can be comprehensively collected. When the index values for the specific railroad track 10 are collected, the index values may be sequentially updated to latest data.

The determination processing device 70 downloads data in which the index value and the position in the railroad track 10 are associated with each other from the data server 90, and determines necessity of maintenance based on the index value. In the present embodiment, the determination processing device 70 is provided in an optional position other than the railroad track 10. For example, the determination processing device 70 is provided to a management base 28 disposed on a ground to monitor the railroad track 10. The determination processing device 70 may be provided to a base for performing a maintenance operation. The determination processing device 70 may be mounted to a mobile terminal device and carried by an operator, or may also be provided with determination processing of a determination processing device on the data server 90. When the data server 90 is the cloud server, the data server 90 may have a determination processing function of the determination processing device in the cloud server.

The communication network 38 described above may be a wired or wireless communication network, and may be a combination of the wired and wireless communication networks. The communication network 38 may be a public communication network or a communication network using a dedicated line. The data in which the index value and the position in the railroad track 10 are associated with each other may be directly transmitted from the ballast condition monitoring device 40 to the determination processing device 70. In this case, the data server 90 may be omitted.

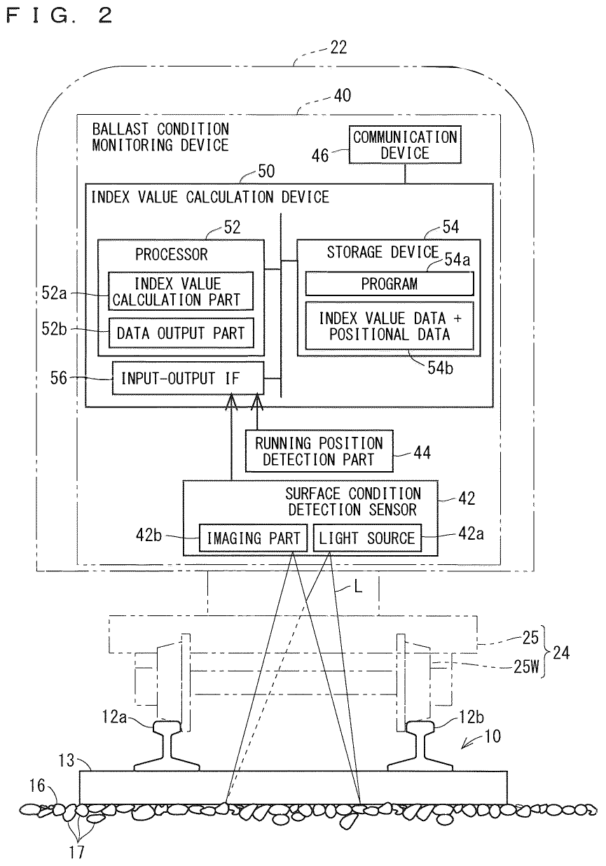

FIG. 2 is a block diagram illustrating the ballast condition monitoring device 40.

The surface condition detection sensor 42 is supported by the railroad car 20, and detects the surface condition of the ballast 16 in the running position of the railroad car 20 during running of the railroad car 20. The surface condition detection sensor 42 may be a sectioning method shape measurement device, for example. An optical sectioning method shape measurement device includes a slit light source 42a and an imaging part 42b. The slit light source 42a emits slit light L toward the ballast 16 along a width direction of the ballast 16. The width direction of the ballast 16 is a direction connecting the rails 12a and 12b, and is also a direction along the tie 13. The imaging part 42b is an imaging camera, and takes an image including the slit light L. The optical sectioning method shape measurement device obtains surface shape data of the ballast 16 in a cross-section along the width direction of the ballast 16 based on a principle of triangulation in accordance with a position of a slit in the taken image. The surface shape data is data indicating an up-down coordinate position of a surface of the ballast 16 with respect to each coordinate on a line along the width direction of the ballast 16, for example. A processor calculating the coordinate position of the surface of the ballast 16 may be incorporated into the surface condition detection sensor 42 or the index value calculation device 50.

The surface condition detection sensor 42 may not necessarily be the sectioning method shape measurement device. For example, it is sufficient that the surface condition detection sensor 42 is a sensor which can detect a height of concave-convex parts of the ballast 16 in the line along the width direction of the ballast 16. In this manner, the surface condition detection sensor 42 detecting a surface height in a predetermined line may be a sensor in which distance sensors are arranged in a form of a line or a sensor obtaining three-dimensional data based on images taken by imaging devices, for example. The latter sensor may be a so-called stereo camera.

The surface condition detection sensor 42 needs not to detect the height of the concave-convex parts of the surface of the ballast 16 in the predetermined line. For example, the surface condition detection sensor 42 may be a sensor providing data from which a size of the block object 17 can be distinguished in a region of the ballast 16 observed from above. In this manner, the surface condition detection sensor 42 providing the data from which the size of the block object 17 in the observed region can be distinguished may be a single imaging part, for example. The reason is that edge extraction processing, for example, is performed on a boundary of the block object 17 in the image obtained by the imaging part, thus the size of the block object 17 can be distinguished. Needless to say, the surface condition detection sensor 42 providing the data from which the size of the block object 17 can be distinguished may be a sensor obtaining three-dimensional data in the observed region based on images taken by the imaging devices.

That is to say, it is sufficient that the surface condition detection sensor 42 can detect and output the surface condition of the ballast 16 which can be used for converting the degree of grain size of the block object 17 into the index value regardless of whether a target to be detected is a line or a planarly-spreading region.

The surface condition detection sensor 42 is supported by the railroad track 10 in a position where the surface condition detection sensor 42 can detect the surface condition of at least a part of a region between the first rail 12a and the second rail 12b in the ballast 16. For example, the surface condition detection sensor 42 is supported in a lower part of the body 22. The surface condition detection sensor 42 is located between the wheels 25 W on the right and left sides in a car width direction. The surface condition detection sensor 42 is supported by the body 22 in a posture of detecting a region between the first rail 12a and the second rail 12b. For example, it is set that the slit light L from the slit light source 42a is emitted between the rails 12a and 12b, and the region in which the imaging part 42b takes an image includes a region in which the light is emitted from the slit light source 42a between the rails 12a and 12b. Accordingly, the surface condition detection sensor 42 can detect the surface condition of at least a part of the region between the first rail 12a and the second rail 12b in the ballast 16. The surface condition detection sensor 42 may be supported by the trucks 24.

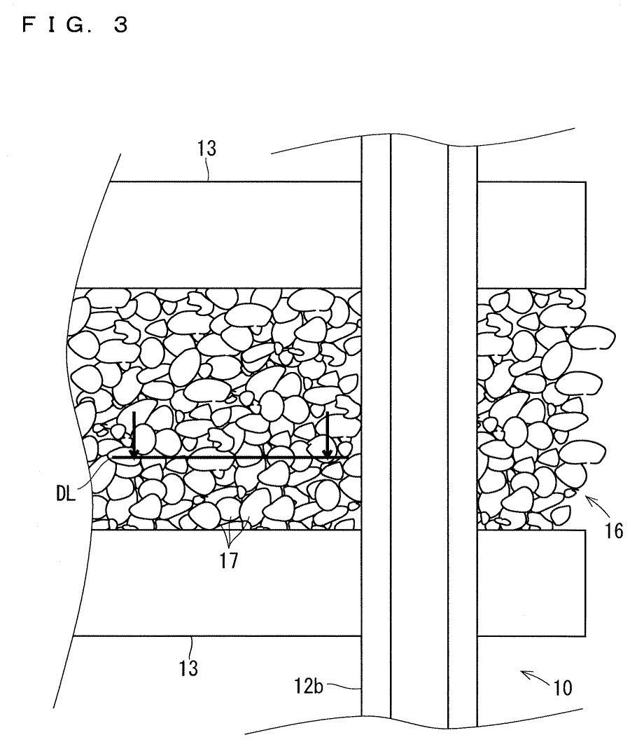

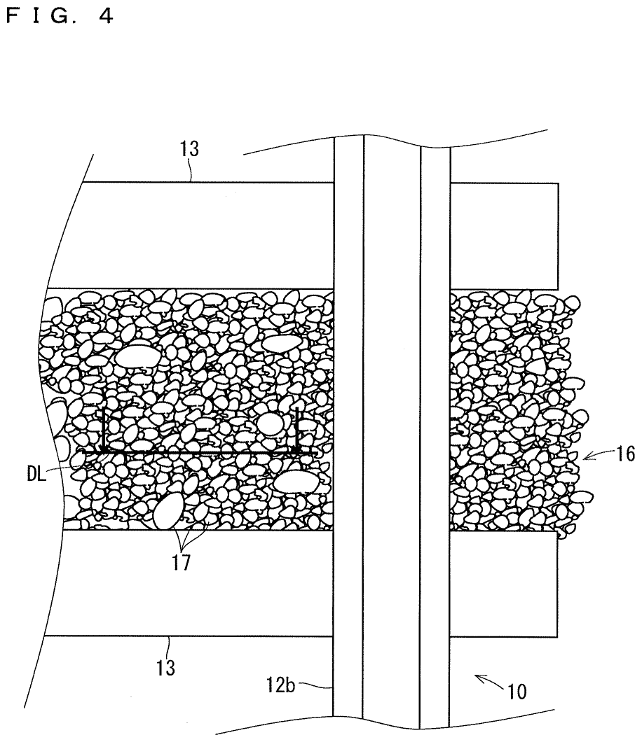

FIG. 3 and FIG. 4 are explanation diagrams each illustrating an example of a condition of the ballast 16 and a detection line DL between the rails 12a and 12b.

The ballast 16 is bedded on the laying surface as illustrated in FIG. 3, and the block objects 17 are located between the rails 12a and 12b. Immediately after bedding the ballast 16, the block object 17 has a size large enough to diffuse vibration in passage of the railroad car 20, improve drainage performance, and prevent growth of plant weeds. When the railroad car 20 runs repeatedly, decrease in the grain sizes of the block objects 17 proceeds by contact of the block objects 17 with each other, and the sizes of the block objects 17 decrease as illustrated in FIG. 4.

The surface condition detection sensor 42 detects height information of the surface of the ballast 16 in each position on the detection line DL, for example. A difference of surface shape data of a ballast in the detection line DL before and after the proceeding of the decrease in the grain size of the ballast 16 is as follows. That is to say, the surface shape data before the decrease in the grain size indicates a shape regulated by the surface shape of the block object 17 larger than the block object 17 after the decrease in the grain size. The surface shape data after the decrease in the grain size indicates a shape regulated by the surface shape of the block object 17 smaller than the block object 17 before the decrease in the grain size. Thus, the surface shape data before the decrease in the grain size and the surface shape data after the decrease in the grain size indicate different degrees of grain size, and the surface shape data before the decrease in the grain size is rougher than the surface shape data after the decrease in the grain size. Thus, the value indicating the degree of grain size can be converted into the index value based on the surface shape data. The necessity of maintenance of the ballast 16 can be determined based on the calculated index value indicating the degree of grain size.

As illustrated in FIG. 2, the running position detection part 44 detects the condition for specifying the running position of the railroad car 20 during running of the railroad car 20. The running position of the railroad car 20 is a position of the railroad car 20 in a longitudinal direction of the railroad track 10. The running position of the railroad car 20 may be a position (for example, kilometrage) based on a fixing position in the longitudinal direction of the railroad track 10 (for example, starting point of a railroad or a certain station), or may also be a position based on an optional position in the longitudinal direction of the railroad track 10. For example, the running position detection part 44 may include a rotation number detection sensor detecting the number of rotations of the wheels, and output a running distance based on the detection result of the rotation number detection sensor from a certain position. A sensor detecting a speed of car based on the number of rotations in the railroad car 20 is also referred to as a speed generator in some cases. The running distance is specified by integrating the speed, thus the running position detection part 44 including the rotation number detection sensor may output speed every predetermined period of time.

For example, the running position detection part 44 may include a global positioning system (GPS) receiving part in a global navigation satellite system (GNSS), and output latitude-longitude information obtained by a receiving signal from the GPS receiving part or a position in the longitudinal direction of the railroad track 10 based on the latitude-longitude information.

The index value calculation device 50 is made up of a computer including a processor 52 such as a CPU, a storage device 54, and an input-output interface 56, for example. Output from the surface condition detection sensor 42 and the running position detection part 44 described above is inputted to the input-output interface 56.

The processor 52 includes a calculation circuit. The processor 52 is an example of a processing part calculating the index value indicating the degree of grain sizes of the block objects 17 spread as the ballast 16 based on the data indicating the surface condition of the ballast 16. The processor 52 is also an example of a processing part generating data in which the index value is associated with the positional data in the railroad track 10. The storage device 54 is made up of a non-volatile storage device such as a hard disk drive (HDD) and a solid-state drive (SSD). The storage device 54 stores a program 54a and data 54b in which the positional data is associated with index value data.

Processing for the processor 52 to achieve a function as the processing part is described in the program 54a. Accordingly, the processor 52 executes the processing described in the program 54a stored in the storage device 54, for example, thus the processing as the processing part calculating the index value is executed. For example, the processor 52 executes each function as an index value calculation part 52a calculating the index value and a data output part 52b. The number of the processors 52 may be one, or the plurality of processors 52 are also applicable. The processors 52 may be incorporated into one computer. It is also applicable that the processors 52 are incorporated into computers, and the computers separately perform processing as the processing parts calculating the index value.

The data 54b stored in the storage device 54 is data in which a position of the railroad car 20 where the condition of the ballast 16 corresponding to the index value is detected is associated with the index value calculated based on the data indicating the surface shape of the ballast 16.

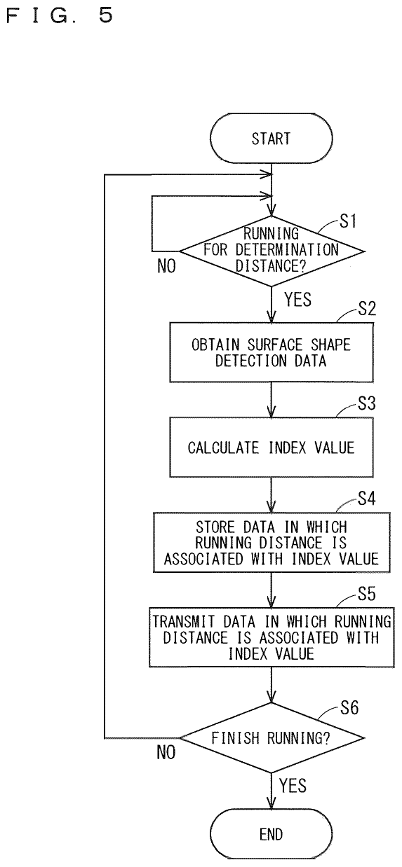

A processing example of the processing part in the index value calculation device 50 is described with reference to a flow chart illustrated in FIG. 5.

In Step S1, it is determined whether or not the railroad car 20 has run a determination distance based on the output from the running position detection part 44. The determination distance indicates a preset value as an interval calculating the index value. For example, the determination distance is set to d(m). In this case, when a running distance obtained by subtracting an initial position or a running position calculated by a previous index value from a current running position of the railroad car 20 is smaller than d(m), the determination is NO, and when it is larger than d(m), the determination is YES. When the running distance of the railroad car 20 is d(m), the determination may be any of YES and NO. The determination distance d(m) may be 0.5 (m), 1 (m), 2 (m), 5 (m), or may also be longer such as 10 (m) or 50 (m), for example. When the determination is NO in Step S1, the processing of Step S1 is repeated, and when the determination is YES, the processing proceeds to next Step S2.

In Step S2, the detection data of the surface shape of the ballast 16 is obtained from the surface condition detection sensor 42.

In Steps S1 and S2, the surface condition detection sensor 42 may be operated for each running of determination distance based on the output from the running position detection part 44 to obtain the surface shape data. For example, it is also applicable that the slit light source 42a emits the slit light and the imaging part 42b performs the imaging operation for each running of determination distance. The operation subsequent to Step S3 may be performed when the surface shape data for each running of determination distance is inputted to the index value calculation device 50 from the surface condition detection sensor 42.

In next Step S3, the index value is calculated based on the obtained surface shape data. An example of the calculation of the index value is described hereinafter.

In next Step S4, the running position of the railroad car 20 used for the determination in Step S1 is associated with the index value calculated in Step S3, and is stored as the data 54b in the storage device 54.

In next Step S5, the data 54b in which the running position of the railroad car 20 is specified in the index value is transmitted via the communication device 46. The data 54b is stored in the data server 90. It is also applicable that the data 54b is transmitted every time the index value is calculated, every time the railroad car 20 travels a predetermined distance or every time a predetermined number of index values are calculated, every time the railroad car 20 stops, or at the end of the running operation. After the transmission processing, the data 54b in the storage device 54 may be deleted. The communication device 46 may be omitted. In this case, the data 54b stored in the storage device 54 may be collected via a portable storage medium.

In next Step S6, finish of the running operation of the railroad car 20 is determined. The finish of the running operation is determined by whether or not the railroad car 20 has reached a terminal station or a power source is turned off, for example. When it is determined that the running of the railroad car 20 is finished, the processing is finished, and when it is determined that the running of the railroad car 20 is not finished, the processing returns to Step S1, and the processing described above is repeated.

Accordingly, in the railroad on which the railroad car 20 runs, the data in which the position in the railroad track 10 is associated with the index value is obtained for each running of the determination distance described above.

An example of calculation processing of the index value is described.

The index value may be calculated by fractal dimension analysis. More specifically, the index value may be calculated by fractal dimension analysis by a box counting method.

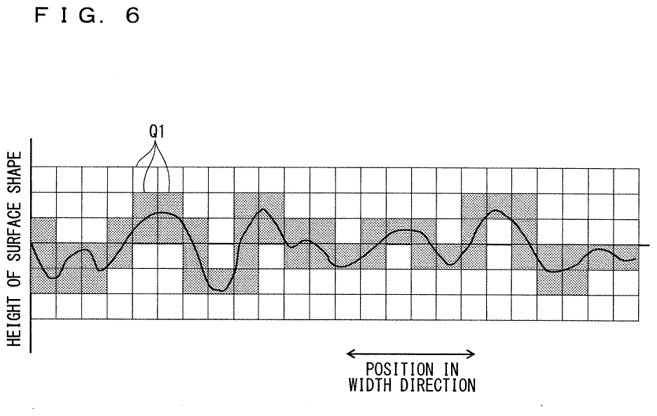

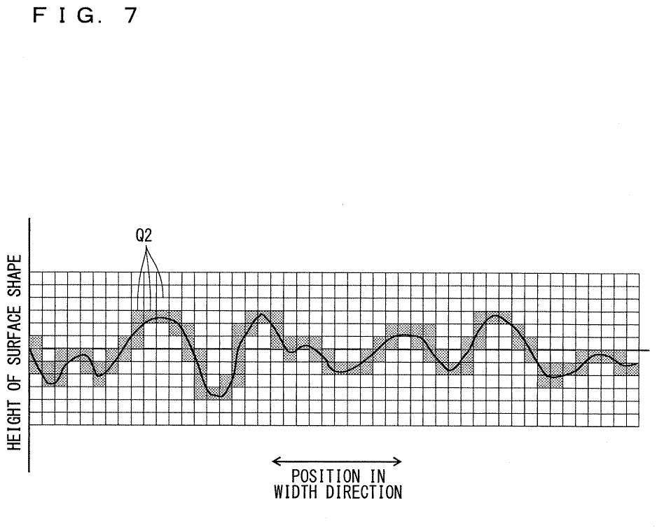

FIG. 6 and FIG. 7 are diagrams each illustrating a processing example of fractal dimension analysis by a box counting method.

As illustrated in FIG. 6, expressed is the surface shape of the ballast 16 in the detection line DL along the width direction of the ballast 16. When the surface shape data is a coordinate data expressing a height of the surface of the ballast 16 in the detection line DL, the surface shape of the ballast 16 is expressed based on the data. When the surface shape data is image data, the surface shape of the ballast 16 in the detection line DL is expressed by performing edge extraction processing, for example.

A quadrangular cell Q1 is vertically and laterally set in a plane in which the surface shape of the ballast 16 in the detection line DL is expressed. In each cell Q1, the number of cells through which a boundary line indicating the surface shape of the ballast 16 passes is counted (refer to the cells Q1 assigned with halftone dots in FIG. 6).

Subsequently, as illustrated in FIG. 7, a cell Q2 having a similarity shape but having a size different from the cell Q1 is set. In each cell Q2, the number of cells through which a boundary line indicating the surface shape of the ballast 16 passes is counted (refer to the cells Q2 assigned with halftone dots in FIG. 7) in the manner similar to the above description.

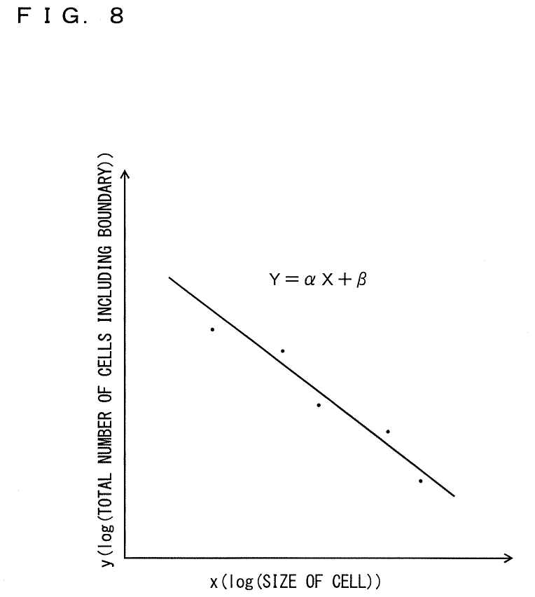

Repeated is processing of counting the number of cells through which the boundary line indicating the surface shape of the ballast 16 passes while changing the size of the cell. Then, the size of the cell and the total number of cells including the boundary are logarithmically converted. A relationship between the size of the cell and the total number of cells including the boundary is expressed by a double logarithmic graph illustrated in FIG. 8.

A regression expression indicating a relationship between a logarithmic conversion value X of the size of the cell and a logarithmic conversion value Y of the total number of the cells including the boundary (Y=αX+β) is calculated by a least-square method. An absolute value of a regression coefficient α in the regression expression is calculated as a fractal dimension.

The fractal dimension a increases as an analysis target object gets rougher, and decreases as the analysis target object gets finer. Thus, the fractal dimension a is used as the index value indicating the degree of grain size of the ballast 16.

The calculation of the index value by the fractal dimension analysis can also be applied to a case where the condition of the surface of the ballast 16 is image data in which the size of the block object 17 in a region where the ballast 16 is observed from above can be distinguished. For example, it is also applicable that processing of extracting an edge of a boundary of each block object 17 is executed on the image data and the index value is calculated by executing the fractal dimension analysis on the boundary of each block object 17 by a box counting method in the manner similar to the above description. The edge may be extracted by processing of applying an edge extraction filter to the image data. For example, a Sobel filter or a Laplacian filter may be applied as the edge extraction filter.

The index value may be calculated by an arithmetic average roughness.

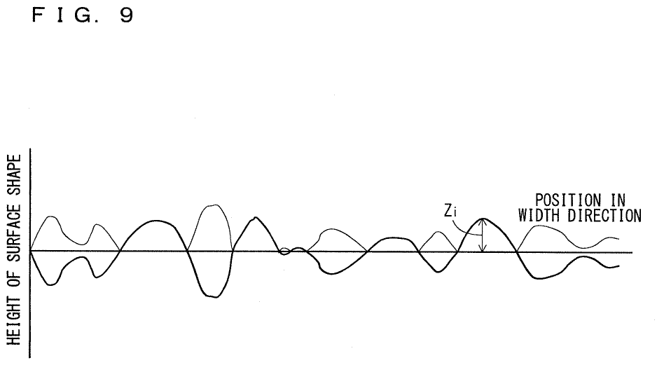

FIG. 9 is a diagram illustrating a processing example of calculating the arithmetic average roughness. As illustrated in FIG. 9, expressed is the surface shape of the ballast 16 in the detection line DL along the width direction of the ballast 16. The surface shape is based on the same obtained data as the surface shape in the fractal dimension analysis.

A height position Zᵢ of the surface shape of the ballast 16 is obtained for each coordinate with equal intervals in the width direction of the ballast 16 based on the surface shape of the ballast 16 in the detection line DL. The height position Zᵢ is expressed by a height with respect to average height positions of the surface shape of the ballast 16 in the detection line DL, for example.

As indicated by Expression 1 described hereinafter, an arithmetic average roughness Ra is calculated by dividing a total sum of an absolute value of the height position Zᵢ of each coordinate i on the detection line DL by a total number of the coordinates i.

$$Ra = \frac{1}{N} {\sum }_{i = 1}^{N} \vert {Z}_{i} \vert \qquad [ Expression 1 ]$$

The degree of grain size of the ballast 16 may be obtained by calculation processing other than that described above. For example, a maximum height as a distance from a highest point to a lower point of the surface of the ballast 16 in the detection line DL may be the index value. Various calculation values which can be changed in accordance with the size of the block object 17 can be used as the index value.

The calculated index value is associated with the position of the railroad track 10, and is stored in the storage device 54 of the data server 90. The determination processing device 70 downloads the data from the data server 90 to execute the processing.

As illustrated in FIG. 1, the determination processing device 70 is made up of a computer including a processor 72 such as a CPU, a storage device 74, and a communication device 76, for example. The determination processing device 70 is communicably connected to data server 90 via a communication line in a wired system, for example.

The determination processing device 70 receives the collection data 92a stored in the data server 90 and stores the collection data 92a in the storage device 74. Collection data 74b downloaded into the storage device 74 may be part of data belonging to the railroad track 10 to be evaluated in the collection data 92a in the data server 90. The processor 72 executes processing according to the program 74a stored in the storage device 74 as a maintenance necessity determination processing part, thereby executing processing of determining necessity of maintenance in accordance with the index value. For example, the processor 72 compares the index value with a reference value included in reference value data 74d stored in the storage device 74, thereby determining the necessity of maintenance. The necessity of maintenance may be determined as a degree of necessity of maintenance (maintenance level). A determination result 74c is associated with the position of the railroad track 10 to be stored in the storage device 74.

A display device 78 and an input part 79 are connected to the determination processing device 70. The display device 78 may be a liquid crystal display device or an organic electro-luminescence (EL) display device, for example. A display device provided to a smartphone or a tablet terminal, for example, may be used as the display device 78. The input part 79 receives instructions from a user on the determination processing device 70. The input part 79 may be a key board, a mouse, a touch panel including switches, for example. The determination result of the necessity of maintenance on the ballast 16 of the railroad track 10 described above may be displayed in the display device 78.

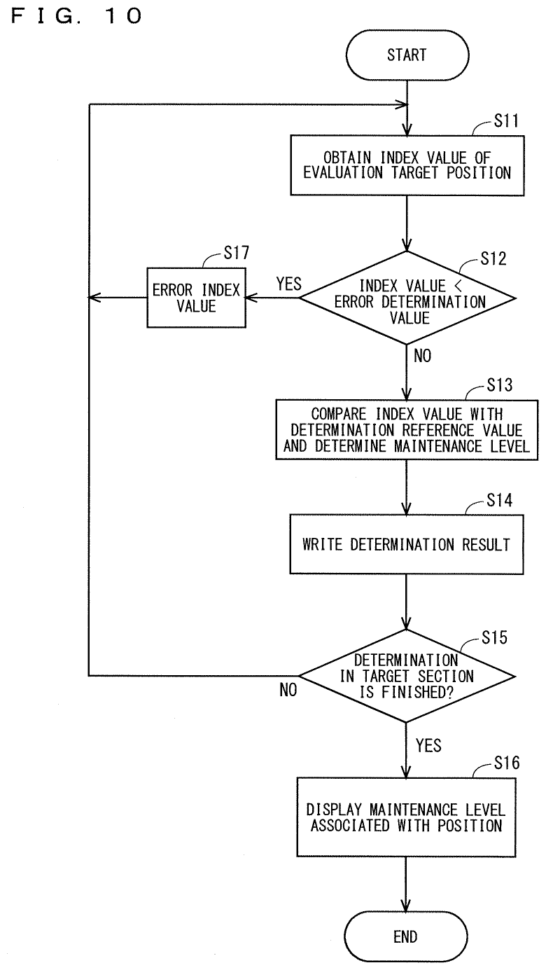

A processing example of the determination processing device 70 is described with reference to a flow chart illustrated in FIG. 10.

In Step S11, the index value of the evaluation target position is obtained. For example, a part of a section in the railroad track 10 is designated as an evaluation target section by a user via the input part 79. The index value in one position in the evaluation target section is obtained from the collection data 74b of the storage device 74.

In next Step S12, it is determined whether or not the index value is smaller than an error determination value. The error determination value is data defined in the reference value data 74d, and is a preset value. The error determination value is a value indicating a clearly smoother condition than the surface of the ballast 16 in which the grain size is reduced, for example. For example, it is considered that the ballast 16 is clearly rougher than the surface of the tie 13 even when decrease in the grain size of the ballast 16 proceeds. Thus, for example, the error determination value is set to a value between the index value of the surface shape of the ballast 16 in which decrease in the grain size proceeds and the index value of the surface shape of the tie 13.

In Step S12, when the index value is determined to be smaller than the error determination value, the processing proceeds to Step S17, and the index value is determined to be the error index value. When the index value is determined to be the error index value, the error index value is not used as a value for determining necessity of maintenance of the ballast 16. After Step S17, the processing returns to Step S11 to obtain the index value of the other evaluation target position, and the processing described above is repeated.

When it is determined that the index value is not smaller than the error determination value in Step S12, the processing proceeds to Step S13. When the index value is the same as the error determination value, the processing may or may not proceed to Step S13.

The processing of Steps S12 and S17 is performed, thus even when the surface condition detection sensor 42 detects the surface shape of the tie 13 instead of the ballast 16, suppressed is the determination of the necessity of maintenance of the ballast 16 based on the surface shape data of the tie 13. For example, when the surface condition detection sensor 42 detects the surface condition every time the railroad track 10 runs a predetermined determination distance, it may detect the surface shape data of the tie 13. The index value based on such a surface shape data of the tie 13 can be excluded from the determination of necessity of maintenance. The processing of Step S12 may be performed after the index value calculation processing in the index value calculation device 50. In this case, the error index value may be excluded from the data transmitted outside from the railroad track 10. The processing in Step S12 may be performed in the data server 90.

In Step S13, the index value is compared with a determination reference value to determine a maintenance level indicating the necessity of maintenance. For example, as the decrease in the grain size of the ballast 16 proceeds, a degree of necessity of maintenance of the ballast 16 increases. Thus, a plurality of maintenance levels are previously set in accordance with a degree of necessity (caution level) of maintenance. The maintenance level corresponding to the index value can be experientially set in accordance with the degree of grain size of the ballast 16 corresponding to the index value. The index value is compared with the determination reference value, thus the maintenance level in each position in the railroad track 10 is determined. The maintenance level indicates a degree of proceeding of decrease in the grain size of the ballast 16, and it is also considered that the decrease in the grain size of the ballast 16 proceeds as the maintenance level increases. It is also applicable that one determination reference value is set and maintenance level includes two levels simply indicating necessity of caution. It is also applicable that a plurality of determination reference values are set and maintenance level includes three or more levels. It is sufficient that the maintenance level is distinguished from each other based on the determination reference value as a threshold value. When the index value has the same value as the determination reference value, the index value may be determined to belong to any level of previous or next value of the determination reference value.

In next Step S14, the determination result 74c is written in the storage device 74 in association with the position in the railroad track 10.

In next Step S15, it is determined whether or not the determination in a target section has been finished. When it is determined that the evaluation determination on all of positions included in the target section is finished, the processing proceeds to Step S16, and when it is determined that the evaluation determination is not finished, the processing returns to Step S11 and the processing described above is repeated. Accordingly, the maintenance level is determined on the index value corresponding to each position of all of the determination distances included in the target section.

In Step S16, a ballast condition image indicating the condition of the ballast 16 in the railroad track 10 is displayed in the display device 78 based on the determination result of necessity of maintenance. Subsequently, the processing is finished.

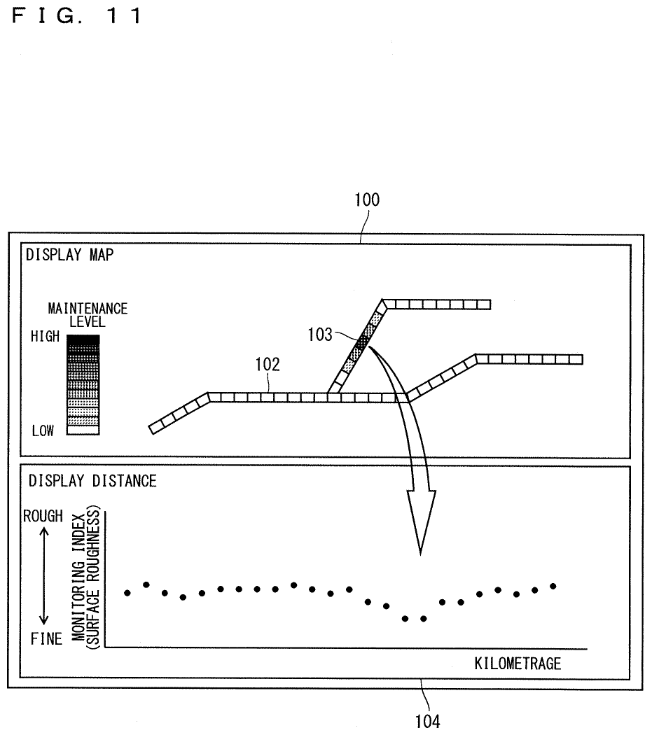

FIG. 11 is a diagram illustrating an example of a ballast condition image 100. The ballast condition image 100 is an image in which the condition of the ballast 16 is associated with the position in the railroad track 10, for example.

In FIG. 11, the maintenance level is associated with each section of the railroad track 10. The image includes a track image 102 expressing the actual railroad track 10. The track image 102 includes a maintenance level image 103 displaying the maintenance level. The maintenance level image 103 may be identified by a color, a contrasting density, or a pattern, for example. For example, the maintenance level may be distinguished to have a higher degree as a color makes a transition from a green color to a red color via a yellow color. A position in the railroad track 10 where caution should be given to the condition of the ballast 16 is easily grasped by seeing this image.

Each section of the railroad track 10 is considered to include a plurality of positions in which the index value is evaluated depending on a display scale of the railroad track 10. In this case, it is also applicable to display the maintenance level image 103 corresponding to a highest maintenance level in the evaluation results in the plurality of positions.

A detailed image 104 expressing the index value may be displayed in a range in which the track image 102 is partially enlarged is displayed separately from the track image 102. The detailed image 104 is a graph having a lateral axis indicating a position (for example, kilometrage) in a longitudinal direction of the railroad track 10 and a vertical axis indicating the index value. The detailed image 104 may be displayed by selecting a part of the track image 102 by a click or a touch operation, for example. A condition of a part of the railroad track 10 can be grasped more specifically by this detailed image 104.

The ballast condition image may be an image in which a position where the maintenance is necessary is displayed in a display form corresponding to the maintenance level. The ballast condition image may be an image including a message identifying the position where the maintenance is necessary and the maintenance level.

According to the ballast condition monitoring device 40, the ballast condition monitoring system 30, and the ballast condition monitoring method having such configurations, the index value indicating the degree of grain sizes of the block objects 17 spread as the ballast 16 is calculated based on the data indicating the surface condition of the ballast 16 in the railroad track 10. Thus, the condition of the ballast can be monitored based on the degree of grain sizes of the block objects 17 spread as the ballast 16.

The index value is calculated based on the data indicating the surface condition of the ballast 16, thus the condition of the ballast 16 is quantitively monitored without an personal difference.

When the surface shape data in the cross-section along the width direction of the ballast 16 is used as the data indicating the surface condition of the ballast 16, the surface shape data in the cross-section along the width direction of the ballast 16 can be processed as outline data including the height information of the surface of the ballast 16. Thus, the index value can be calculated with a less calculation amount compared with a case of performing processing based on planar data of the surface of the ballast 16. A concave-convex condition of the height of the ballast 16 is reflected to the index value, thus the degree of grain sizes of the block objects 17 is easily reflected with accuracy.

The fractal dimension or the arithmetic average roughness is obtained as the index value, thus the degree of grain sizes of the block objects can be expressed.

The index value is associated with the positional data, thus the monitoring can be performed while the index value is associated with the position in the railroad track 10.

The ballast condition monitoring device 40 includes the surface condition detection sensor 42 supported by the railroad car 20 and capable of detecting the surface condition of the ballast 16 during running of the railroad car 20. Thus, the surface shape data can be sequentially obtained during running of the railroad car 20. Accordingly, the condition of the ballast 16 in the railroad track 10 can be easily monitored without an inspector going to each area in the railroad track 10.

When the railroad car 20 supporting the surface condition detection sensor 42 is a commercial car for transporting a human or a baggage, the condition of the ballast 16 in the railroad track 10 on which the commercial car runs can be obtained extensively and frequently.

When the surface condition detection sensor 42 is supported by the railroad car 20 in a position where the surface condition detection sensor 42 can detect the surface condition of at least a part of the region between the rails 12a and 12b in the ballast 16, the surface condition detection sensor 42 continuously detects the surface condition of the ballast 16 easily. Assumed, for example, is a case where the surface condition detection sensor 42 detects an outer side region beyond the region between the rails 12a and 12b. Assumed in this case is that when the railroad car 20 is inclined at a curve, for example, a region to be detected is beyond the region of the ballast 16. In the case where the surface condition detection sensor 42 detects the region between the rails 12a and 12b, the region to be detected is hardly beyond the ballast 16 even when the railroad car 20 is inclined at the curve, for example.

The determination processing device 70 determines the necessity of maintenance based on the index value, thus the necessity of maintenance can be determined by a stable standard based on the index value.

Assumed in a case where the index value is small is a case where data indicating the surface condition of the ballast is data indicating the surface condition of the tie 13. Thus, the index value and the predetermined error determination value are compared, and when the index value is considered to express the surface condition of the tie 13, or when the index value is smaller than the error determination value, for example, the index value may be determined to be the error index value. Accordingly, the index value corresponding to the tie 13 is distinguished as the error index value, and the condition of the ballast can be monitored by the index value other than the error index value.

The condition of the ballast 16 can be easily grasped by displaying the ballast condition image in the display device 78.

When the ballast condition image 100 is an image with which the maintenance level image 103 indicating the condition of the ballast 16 is associated in the position of the track image 102 corresponding to the railroad track 10, the condition of the ballast 16 corresponding to the position of the railroad track 10 is easily grasped.

The example of the index value calculation device 50 mounted to the railroad car 20 is described in the above embodiment. It is also applicable that the index value calculation device 50 is mounted to the data server 90 or the determination processing device 70, and the index value calculation processing is performed in the data server 90 or the determination processing device 70. In this case, it is sufficient that the surface condition detection sensor 42 and the running position detection part 44 are mounted to the railroad car 20, and the output data from the surface condition detection sensor 42 and the running position detection part 44 is transmitted to the data server 90 or the determination processing device 70 via the communication device 46.

The example of the determination processing device 70 disposed in the position separately from the railroad car 20 is described in the above embodiment. It is also applicable that the determination processing device 70 is mounted to the railroad car 20 and the determination processing is performed in the railroad car 20. In this case, it is also applicable that the determination result is transmitted to the data server 90 or a computer operated by a maintenance manager or a maintenance operator, and the ballast condition image based on the determination result is displayed in the computer operated by the maintenance manager or the maintenance operator.

The description of the above embodiment is based on the premise that the index value gets smaller as the grain size of the ballast 16 decreases. When the index value increases as the grain size of the ballast 16 gets smaller, the processing of comparing the magnitude of the index value and the error determination value or the determination reference value may be opposite to that in the above description.

Each configuration described in the above-mentioned embodiment and modification examples can be combined with each other as appropriate unless any contradiction occurs.

The present disclosure discloses each aspect described hereinafter.

A first aspect is a ballast condition monitoring system including: an input part to which data indicating a surface condition of a ballast in a railroad track is inputted; a processing part calculating an index value indicating a degree of grain size of the ballast based on the data indicating the surface condition of the ballast inputted to the input part; and a maintenance necessity determination processing part determining necessity of maintenance based on the index value. Accordingly, necessity of maintenance can be determined based on the index value.

A second aspect is the ballast condition monitoring system according to the first aspect, wherein the data indicating the surface condition of the ballast is surface shape data in a cross section along a width direction of the ballast.

In this case, the surface shape data in the cross section along the width direction of the ballast can be processed as the outline data including the height information of the surface of the ballast. Thus, the surface shape data contributes to calculation of the index value with a less calculation amount compared with a case of performing the processing based on the planar data of the surface of the ballast. The concave-convex condition of the ballast is reflected to the index value, thus the degree of grain sizes of the block objects is easily reflected with accuracy.

A third aspect is the ballast condition monitoring system according to the first aspect, wherein the data indicating the surface condition of the ballast is image data in a region in which the ballast is observed from above, and the processing part performs edge extraction processing on the image data to calculate the index value indicating the degree of grain size of the ballast. Accordingly, the index value can be calculated based on the image data.

A fourth aspect is the ballast condition monitoring system according to any one of the first to third aspects, wherein the processing part obtains a fractal dimension based on the data indicating the surface condition of the ballast as the index value. In this case, the degree of grain sizes of the block objects can be expressed by the fractal dimension.

A fifth aspect is the ballast condition monitoring system according to the fourth aspect, wherein the processing part performs fractal dimension analysis by a box counting method on the data indicating the surface condition of the ballast to obtain the fractal dimension. The fractal dimension is easily obtained by the box counting method.

A sixth aspect is the ballast condition monitoring system according to the first or second aspect, wherein the processing part obtains an arithmetic average roughness based on the data indicating the surface condition of the ballast as the index value. In this case, the degree of grain sizes of the block objects can be expressed by the arithmetic average roughness.

A seventh aspect is the ballast condition monitoring system according to any one of the first to sixth aspects, wherein the maintenance necessity determination processing part determines necessity of maintenance by comparing the index value with a predetermined reference value. Accordingly, the necessity of maintenance can be easily determined.

An eighth aspect is the ballast condition monitoring system according to any one of the first to seventh aspects, wherein the processing part generates data in which the index value is associated with positional data in a railroad track. Accordingly, the monitoring can be performed while the index value is associated with the position in the railroad track.

A ninth aspect is the ballast condition monitoring system according to any one of the first to eighth aspects, further comprising a surface condition detection sensor supported by a railroad car running on the railroad track and capable of detecting the surface condition of the ballast during running of the railroad car. Accordingly, the surface condition of the ballast can be detected during running of the railroad car.

A tenth aspect is the ballast condition monitoring system according to the ninth aspect, wherein the surface condition detection sensor is supported by the railroad car in a position where the surface condition detection sensor can detect a surface condition of at least a part of a region between a first rail and a second rail in the railroad track in the ballast. Accordingly, the surface condition detection sensor continuously detects the surface condition of the ballast easily even when the railroad car is inclined at a curve, for example.

An eleventh aspect is the ballast condition monitoring system according to any one of the first to tenth aspects, wherein when the index value is smaller than a predetermined error determination value, the index value is determined to be an error index value. Assumed is a case where the data indicating the surface condition of the ballast is the data indicating the surface condition of the tie depending on the value of the index value. Such an index value is distinguished as the error index value, and the condition of the ballast can be monitored by the index value other than the error index value.

A twelfth aspect is the ballast condition monitoring system according to any one of the first to eleventh aspects, further comprising a display device, wherein the maintenance necessity determination processing part displays a ballast condition image indicating the condition of the ballast in the railroad track based on a determination result of necessity of maintenance. Accordingly, the condition of the ballast can be grasped by the ballast condition image.

A thirteenth aspect is the ballast condition monitoring system according to the twelfth aspect, wherein the ballast condition image is an image in which a condition of a ballast is associated with a position of a railroad track. Accordingly, the condition of the ballast corresponding to the position of the railroad track can be easily grasped.

A fourteenth aspect is a ballast condition monitoring device including: an input part to which data indicating a surface condition of a ballast in a railroad track is inputted; and a processing part calculating an index value indicating a degree of grain size of the ballast based on the data indicating the surface condition of the ballast inputted to the input part. Accordingly, the condition of the ballast can be monitored based on the degree of grain sizes of the block objects spread as the ballast.

A fifteenth aspect is a ballast condition monitoring method detecting a surface condition of a ballast in a railroad track, calculating an index value indicating a degree of grain size of the ballast based on data indicating the surface condition of the ballast, and outputting a result of the calculation. Accordingly, the condition of the ballast can be monitored based on the degree of grain sizes of the block objects spread as the ballast.

The functionality of the elements disclosed in the present specification may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

According to the ballast condition monitoring system, necessity of maintenance can be determined based on the index value.

According to the ballast condition monitoring system, the condition of the ballast can be monitored based on the degree of grain sizes of block objects spread as the ballast.

According to the ballast condition monitoring method, the condition of the ballast can be monitored based on the degree of grain sizes of block objects spread as the ballast.

The foregoing description is in all aspects illustrative and does not restrict the present invention. It is understood that numerous unillustrated modifications can be devised without departing from the scope of the present invention.

### EXPLANATION OF REFERENCE SIGNS

10 railroad track
12a first rail
12b second rail
13 tie
16 ballast
17 block object
20 railroad car
30 track condition monitoring system
40 track condition monitoring device
42 surface condition detection sensor
44 running position detection part
50 index value calculation device
52 processor
54 storage device
70 determination processing device
72 processor
74 storage device
78 display device
90 data server
100 ballast condition image
102 track image
103 maintenance level image
104 detailed image
DL detection line

1. A ballast condition monitoring system, comprising:
an inputter to which data indicating a surface condition of a ballast in a railroad track is inputted;
circuitry configured to
calculate an index value indicating a degree of grain size of the ballast based on the data indicating the surface condition of the ballast inputted to the inputter; and
determine necessity of maintenance based on the index value.

2. The ballast condition monitoring system according to claim 1, wherein
the data indicating the surface condition of the ballast is surface shape data in a cross-section along a width direction of the ballast.

3. The ballast condition monitoring system according to claim 1, wherein
the data indicating the surface condition of the ballast is image data in a region in which the ballast is observed from above, and
the circuitry is configured to perform edge extraction processing on the image data to calculate the index value indicating the degree of grain size of the ballast.

4. The ballast condition monitoring system according to claim 1, wherein
the circuitry is configured to obtain a fractal dimension based on the data indicating the surface condition of the ballast as the index value.

5.-15. (canceled)

16. The ballast condition monitoring system according to claim 2, wherein
the circuitry is configured to obtain a fractal dimension based on the data indicating the surface condition of the ballast as the index value.

17. The ballast condition monitoring system according to claim 3, wherein
the circuitry is configured to obtain a fractal dimension based on the data indicating the surface condition of the ballast as the index value.

18. The ballast condition monitoring system according to claim 4, wherein
the circuitry is configured to perform fractal dimension analysis by a box counting method on the data indicating the surface condition of the ballast to obtain the fractal dimension.

19. The ballast condition monitoring system according to claim 1, wherein
the circuitry is configured to obtain an arithmetic average roughness based on the data indicating the surface condition of the ballast as the index value.

20. The ballast condition monitoring system according to claim 2, wherein
the circuitry is configured to obtain an arithmetic average roughness based on the data indicating the surface condition of the ballast as the index value.

21. The ballast condition monitoring system according to claim 1, wherein
the circuitry is configured to determine necessity of maintenance by comparing the index value with a predetermined reference value.

22. The ballast condition monitoring system according to claim 2, wherein
the circuitry is configured to determine necessity of maintenance by comparing the index value with a predetermined reference value.

23. The ballast condition monitoring system according to claim 3, wherein
the circuitry is configured to determine necessity of maintenance by comparing the index value with a predetermined reference value.

24. The ballast condition monitoring system according to claim 1, wherein
the circuitry is configured to generate data in which the index value is associated with positional data in a railroad track.

25. The ballast condition monitoring system according to claim 1, further comprising
a surface condition detection sensor supported by a railroad car running on the railroad track and configured to detect the surface condition of the ballast during running of the railroad car.

26. The ballast condition monitoring system according to claim 25, wherein
the surface condition detection sensor is supported by the railroad car in a position where the surface condition detection sensor can detect a surface condition of at least a part of a region between a first rail and a second rail in the railroad track in the ballast.

27. The ballast condition monitoring system according to claim 1, wherein
when the index value is smaller than a predetermined error determination value, the index value is determined to be an error index value.

28. The ballast condition monitoring system according to claim 1, further comprising
a display device, wherein
the circuitry is configured to cause the display device to display a ballast condition image indicating the condition of the ballast in the railroad track based on a determination result of necessity of maintenance.

29. The ballast condition monitoring system according to claim 28, wherein
the ballast condition image is an image in which a condition of a ballast is associated with a position of a railroad track.

30. A ballast condition monitoring device, comprising:
an inputter to which data indicating a surface condition of a ballast in a railroad track is inputted; and
circuitry configured to calculate an index value indicating a degree of grain size of the ballast based on the data indicating the surface condition of the ballast inputted to the inputter.

31. A ballast condition monitoring method, comprising:
detecting a surface condition of a ballast in a railroad track;
calculating an index value indicating a degree of grain size of the ballast based on data indicating the surface condition of the ballast; and
outputting a result of the calculating.
